(19) United States
(12) Patent Application Publication
(10) Pub. No.: US 2009/0211403 A1
(43) Pub. Date: Aug. 27, 2009

(54) SETTING TOOL ARRANGEMENT

(75) Inventor: PAUL GAUDRON, STRATFORD, CT (US)

Correspondence Address: CANTOR COLBURN, LLP, 20 Church Street, 22nd Floor, Hartford, CT, 06103, US

(73) Assignee: POWERS FASTENERS, INC., BREWSTER, NY (US)

(21) Appl. No.: 12/038,248

(22) Filed: Feb. 27, 2008

(51) Int. Cl. B25B 23/00

(52) U.S. Cl. 81/54

(57) ABSTRACT

A setting tool arrangement includes a barrel of a setting tool; and a sleeve interactive with the barrel to move to a position allowing the barrel to move when pointed in a direction opposite the direction of gravity and to a position preventing the barrel from moving when pointed in a direction approximating the direction of gravity and method.

### BACKGROUND

Setting tools are enormously useful for speeding any job requiring the setting of a large number of fasteners. Commonly, such tools are used in connection with setting fasteners in concrete or other hard materials. Because of the materials into which the fasteners are normally set, a substantial amount of motive force is required to be generated to set the fastener. This force is usually generated by the combustion of an energetic or accelerant material. While these tools are undeniably beneficial, they do require care in use to prevent unintended discharge of the fastener at a time when its discharge is unintended. Arrangements that assist in avoiding unintended discharge are always well received by the art.

### SUMMARY

A setting tool arrangement includes a barrel of a setting tool; and a sleeve interactive with the barrel to move to a position allowing the barrel to move when pointed in a direction opposite the direction of gravity and to a position preventing the barrel from moving when pointed in a direction approximating the direction of gravity.

### BRIEF DESCRIPTION OF THE DRAWINGS

Referring now to the drawings wherein like elements are numbered alike in the several Figures:

FIG. 1 is an exploded view of a setting tool to provide for visual environment for the arrangement illustrated alone in FIG. 2;

FIG. 2 is a view of a barrel of a setting tool such as that illustrated in FIG. 1 configured as taught herein in an actuation position; and

FIG. 3 is the view of FIG. 2 in a non-actuation position.

### DETAILED DESCRIPTION

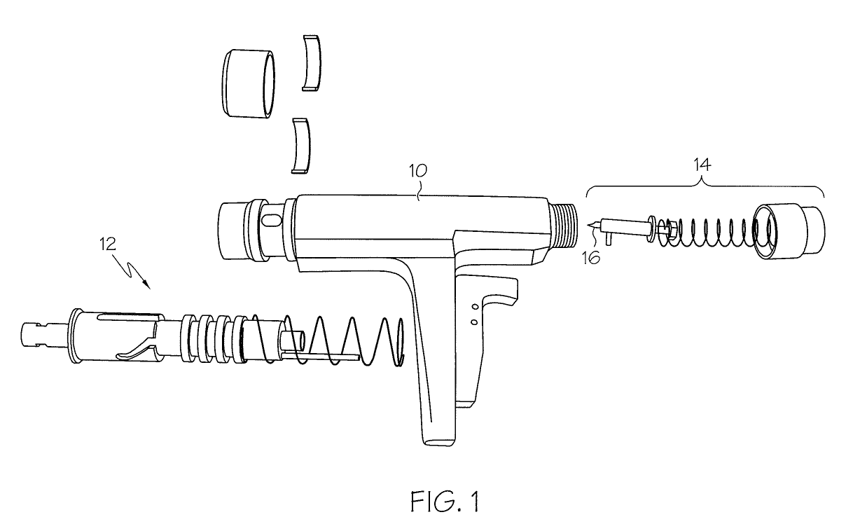

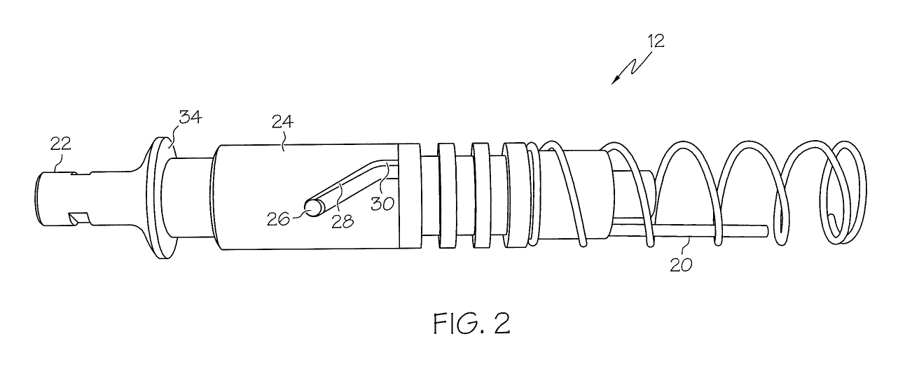

Referring to FIGS. 1 and 2 simultaneously, one of skill in the art will recognize a setting tool stock 10 into which a barrel 12 is slidably receivable. A firing pin assembly 14 is disposable in operable communication with the stock 10 to under compressive conditions of the barrel 12 into the stock 10, the firing pin assembly is automatically set and released. Upon release of the firing pin assembly 14, a firing pin 16 operates to ignite a volume of energetic or accelerant material to create expanding gas thereby driving a fastener (not shown) through the barrel 12 and into a workpiece. In such a tool, having no additional triggering action, the tool will indeed actuate upon any actual compression of the barrel 12 into the stock 10 of the tool. As the particular configuration of setting tool illustrated is for ceiling setting applications, it is often used on ladders or with extension members. In either case, the potential for dropping the device is increased. The dropping of the tool can cause unintended actuation and therefore wasting of accelerant or energetic materials, which are not inexpensive. In order to avoid this eventuality, the configuration of FIG. 2 has been devised by the inventor hereof.

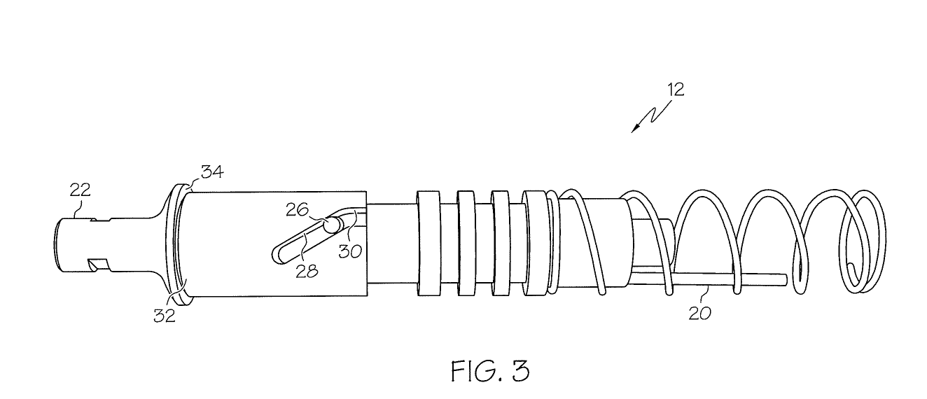

Referring to FIG. 2, the barrel 12, will be generally recognized by one of skill in the setting tool art as having an elongate form, a triggering extension 20, barrel nose 22, etc. What the person of ordinary skill in the art will not recognize is a sleeve 24 disposed about the barrel 12. The barrel 12, in this embodiment, includes at least one lug 26 that is received in a groove 28 of the sleeve 24. In one embodiment, the groove extends all the way through a radial dimension of the sleeve 24. It will be understood that the groove may extend partially through the radial dimension of the sleeve with no functional distinction. In the illustrated embodiment, the groove is at an angle of about 40 degrees to about 50 degrees relative to an axis of the barrel 12. The angle is such that with the nose 22 facing in the direction in which gravity pulls, the sleeve 24 slides closer to nose 22 and the lug 26 moves toward axial groove extension 30, as illustrated in FIG. 3. In the position of FIG. 3, the barrel 12 cannot be compressed into stock 10 because the sleeve 24 is in contact at one axial end 32 with barrel shoulder 34 providing a friction engagement therewith. Increasing force imparted through the lug 26 to the sleeve 24 only increases the frictional engagement. Thus, with the nose 22 pointed downward, the barrel 12 cannot be pushed into the stock 10. Without this action, the tool also cannot be discharged. In the position of FIG. 3 then, the tool is effectively locked. In contrast, when the nose 22 of the tool is pointed in a direction substantially opposite the pull of gravity, the sleeve 24 will automatically move to the position illustrated in FIG. 2. In this position, the barrel is able to move into the stock 10 to actuate the tool.

While the invention has been illustrated in one possible form, it is to be appreciated that the component parts may be reversed while retaining the function hereof. More specifically, the lug 26 may be positioned on the inside dimension of the sleeve 24 and the groove positioned on the outside dimension of the barrel 12. In this configuration the tool works identically to that described above.

While preferred embodiments have been shown and described, modifications and substitutions may be made thereto without departing from the spirit and scope of the invention. Accordingly, it is to be understood that the present invention has been described by way of illustrations and not limitation.

1. A setting tool arrangement comprising:
a barrel of a setting tool; and
a sleeve interactive with the barrel to move to a position allowing the barrel to move when pointed in a direction opposite the direction of gravity and to a position preventing the barrel from moving when pointed in a direction approximating the direction of gravity.

2. The arrangement as claimed in claim 1 wherein the sleeve is disposed around the barrel.

3. The arrangement as claimed in claim 1 wherein the sleeve includes a groove.

4. The arrangement as claimed in claim 3 wherein the groove extends through a radial dimension of the sleeve.

5. The arrangement as claimed in claim 1 wherein the groove is angled relative to an axis of the sleeve.

6. The arrangement as claimed in claim 5 wherein the groove is helical.

7. The arrangement as claimed in claim 5 wherein the angle is from about 40 to about 50.

8. The arrangement as claimed in claim 1 wherein the barrel includes a lug engaged with a groove in the sleeve.

9. The arrangement as claimed in claim 1 wherein the sleeve autorotates to an actuatable position upon the barrel being pointed in a direction generally opposing the direction of pull of gravity.

10. The arrangement as claimed in claim 1 wherein the sleeve autorotates to a non-actuatable position upon the barrel being pointed in a direction of the pull of gravity.

11. The arrangement as claimed in claim 1 wherein the sleeve includes an end surface that is frictionally engaged with a shoulder of the barrel when the barrel is pointed n a direction of the pull of gravity.
